(19) United States
(12) Patent Application Publication
(10) Pub. No.: US 2004/0011408 A1
(43) Pub. Date: Jan. 22, 2004

(54) Pressure reducing valve apparatus and method of the same

(75) Inventor: John Campbell, Winchester, VA (US)

Correspondence Address: MERCHANT & GOULD PC, P.O. BOX 2903, MINNEAPOLIS, MN, 55402-0903, US

(73) Assignee: KIDDE FIRE FIGHTING INC., EXTON, PA

(21) Appl. No.: 10/620,541

(22) Filed: Jul. 16, 2003

Related U.S. Application Data
(60) Provisional application No. 60/396,925, filed on Jul. 17, 2002.

(51) Int. Cl. F16K 37/00

(52) U.S. Cl. 137/554

(57) ABSTRACT

A pressure reducing valve with a tamper proof switch mounted directly on a stem portion of the pressure reducing valve. The switch provides an operating state of the pressure reducing valve in maintaining a predetermined outlet pressure by enabling the pressure reducing valve to be monitored.

### FIELD OF THE INVENTION

The present invention relates generally to a pressure reducing valve used in fluid delivery lines. More particularly, the present invention relates to a pressure reducing valve having a tamper proof switch and a method of monitoring the operating state of a pressure reducing valve having a tamper proof switch.

### BACKGROUND OF THE INVENTION

Pressure reducing valves are well known and widely used, for instance, in fluid delivery systems, such as in sprinkler systems and waterlines of stairwells and hallracks of buildings. Typically, these pressure reducing valves include a switch having signal communication features for monitoring the operating state of the pressure reducing valve.

Previous designs by System Sensor and Potter Electric of switches for installation on a pressure reducing valve have provided a switch operated by a lever. The lever in these designs employs a cantilevered application where the switch is attached to the handwheel of the pressure reducing valve. Rotation of the handwheel or the valve stem causes the lever to move parallel to the direction of travel of the rotating handwheel. This movement of the lever, by movement of the handwheel between open and closed positions of the pressure reducing valve, creates a signal or causes a break in the signal to indicate the operating condition of the pressure reducing valve. Further, such switches are installed on site after manufacture of the pressure reducing valve.

However, present designs do not offer suitable protection of the switch and do not provide the most durable pressure reducing valve. Mounting the switch to the handwheel and using a lever with a cantilever application can result in a pressure reducing valve that is externally bulky and more suspect to tampering. Further, these pressure reducing valves are costly, as they are installed on site, often requiring costs for additional parts and for installation.

Improvements may still be made in providing a pressure reducing valve with a tamper proof switch mounted thereon that is compact and pre-assembled. Furthermore, there is still a need in providing a pressure reducing valve with a tamper proof switch having improved protection and improved durability when mounted to the pressure reducing valve, while maintaining the ability of the switch to monitor the operating state of the pressure reducing valve.

### SUMMARY OF THE INVENTION

In accordance with the present invention, improvements have been made upon existing designs for a pressure reducing valve employing a switch mounted thereon for monitoring the operating state of the pressure reducing valve. The present invention provides a pressure reducing valve with a tamper proof switch mounted on and in direct communication with a stem portion of the pressure reducing valve. The switch is actuatable upon movement of the stem portion and according to an inserted position of the stem portion.

In one embodiment of the present invention, a pressure reducing valve includes a valve having a housing with an inlet and an outlet. The inlet and outlet define a flow passage therethrough. A flow actuating mechanism is connected to the housing, and includes a stem in communication with the inlet and outlet. The stem is rotatably connected to the housing and is at least partially rotatably insertable into the housing. The stem is operable for actuating the valve in an open state or in a closed according to an inserted position of the stem. Further, a tamper switch mechanism is mounted on the stem and in direct communication with the stem. The tamper switch mechanism is actuatable according to the inserted position of the stem. The tamper switch mechanism enables the valve to be monitored in the open and closed states.

In one embodiment of the present invention, a pressure reducing valve includes a flow actuating mechanism having a stem and a handwheel connected at one end of the stem. The handwheel is rotatable with the stem in actuating the pressure reducing valve in the open and closed states. A tamper switch mechanism is mounted on and in direct communication with the stem, and is disposed between the handwheel and a housing of the pressure reducing valve.

In one embodiment of the present invention, the tamper switch mechanism is in direct communication with the stem. The tamper switch mechanism includes an actuator contactable with the stem, and the actuator is used to create a signal or break a signal in providing an operating state of the pressure reducing valve. The actuator is movable to and from the rotational movement of the stem and handwheel, and is movable perpendicular to the movement of the stem into and out of the housing. Preferably, the actuator is deformable by contact with the stem to actuate the tamper switch mechanism. More preferably, the actuator is contactable with the stem in perpendicular compression, thereby actuating the tamper switch mechanism.

In one embodiment of the present invention, the tamper switch may be retrofitted with an existing pressure reducing valve. Preferably, the pressure reducing valve is pre-assembled with the tamper switch at the time of manufacture.

In one embodiment of the present invention, a fluid delivery system includes the above pressure reducing valve having the tamper proof switch and a fluid delivery line connected to a fluid source. The pressure reducing valve is adaptable with the fluid delivery line in order to receive an inlet pressure from the fluid delivery line and control an outlet pressure exiting the pressure reducing valve. Preferably, the outlet pressure is predetermined.

In another embodiment of the present invention, a method for monitoring an operating state of a pressure reducing valve includes mounting a tamper switch mechanism directly on a stem, as on the above described pressure reducing valve, where the tamper switch mechanism is actuatable according to an inserted position of the stem. The tamper switch mechanism is actuated according to the inserted position of the stem or movement thereof. An operating condition of the pressure reducing valve is provided, where the tamper switch mechanism enables the valve to be monitored in the open state and the closed state, according to the inserted position of the stem.

In another embodiment of the present invention, a method for monitoring an operating state of a pressure reducing valve by transmitting signals to a remote location.

The present invention provides a pressure reducing valve with a tamper switch mounted thereon with improved protection and durability characteristics. The configuration of the present invention employs a switch connected to the pressure reducing valve that is tamper proof. For instance, the structure for actuating the switch provides an improvement over cantilevered designs that may flex or buckle from a cantilevered load. The position of mounting the switch offers improved protection and reduces the chance of switch tampering, which can compromise the monitoring operation of the pressure reducing valve. Also, the present invention provides a compact and pre-assembled pressure reducing valve with the switch mounted thereon that is cost effective.

A variety of additional advantages and objects of the invention will be set forth in part in the description which follows, and in part will be obvious from the description, or may be learned by practice of the invention. The advantages of the invention will be realized and attained by means of the elements and combinations particularly pointed out in the claims. It is to be understood that both the foregoing general description and the following detailed description are exemplary and explanatory only and are not restrictive of the invention as claimed.

### BRIEF DESCRIPTION OF THE DRAWINGS

Referring now to the drawings in which like reference numbers represent corresponding parts throughout:

FIG. 1A represents a side view of one embodiment of a pressure reducing valve in accordance with the principles of the present invention.

FIG. 1B represents a rear view of the pressure reducing valve of FIG. 1A.

FIG. 2A represents a partial side view of the pressure reducing valve illustrated in FIG. 1A without a handwheel.

FIG. 2B represents a partial end view of the pressure reducing valve illustrated in FIG. 1B without a handwheel.

FIG. 3 represents a top view of one embodiment of a switch mounted to a stem of the pressure reducing valve of FIGS. 2A and 2B in accordance with the principles of the present invention.

FIG. 4A represents a top view of one embodiment of a switch housing in accordance with the principles of the present invention.

FIG. 4B represents a rear view of the switch housing of FIG. 4A.

FIG. 5A represents a top view of one embodiment of a switch in accordance with the principles of the present invention.

FIG. 5B represents a rear view of the switch of FIG. 5A.

FIG. 6A represents one embodiment of a mounting mechanism for mounting the switch and housing to the stem of a pressure reducing valve in accordance with the principles of the present invention.

FIG. 6B represents a partial end view of one embodiment of a first portion of the mounting mechanism of FIG. 6A in accordance with the principles of the present invention.

FIG. 6C represents a side view of one embodiment of second portion of the mounting mechanism of FIG. 6A in accordance with the principles of the present invention.

FIG. 7A represents a partial side view of the pressure reducing valve of FIG. 2A showing the open position of the valve with the switch in contact with the stem.

FIG. 7B represents a partial side view of the pressure reducing valve of FIG. 2A showing the closed position of the valve with the switch not in contact with the stem.

FIG. 8A represents a schematic view of one embodiment of a wiring diagram for a switch in open and closed positions of a pressure reducing valve.

FIG. 8B represents a schematic view of one embodiment of a wiring diagram for a switch in the open position for a local audible/remote transmitter.

FIG. 8C represents a schematic view of one embodiment of a wiring diagram for a switch in the open position for a local audible/control panel.

### DETAILED DESCRIPTION OF THE PREFERRED EMBODIMENTS

In the following description of the illustrated embodiments, reference is made to the accompanying drawings that form a part hereof, and in which is shown by way of illustration of the embodiments in which the invention may be practiced. It is to be understood that other embodiments may be utilized as structural changes may be made without departing from the spirit and scope of the present invention.

The present invention is directed to a pressure reducing valve with a tamper proof switch mounted thereon. The switch is mounted directly to the stem of the pressure reducing valve. The switch is actuated for monitoring the open and closed operating conditions of the pressure reducing valve, according to movement of an inserted position of the stem between the open and closed conditions of the pressure reducing valve.

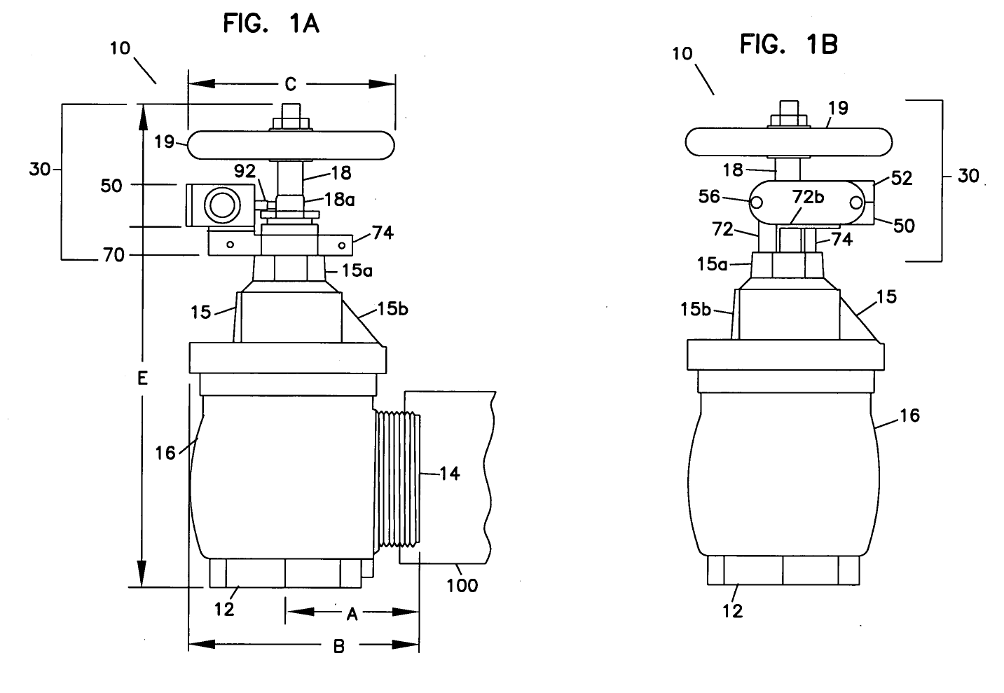

FIGS. 1A and 1B illustrate one preferred example of a pressure reducing valve 10. The pressure reducing valve 10 includes a valve housing 16 having an inlet 12 and an outlet 14. The inlet 12 and outlet 14 define a flow passage (not shown) therethrough.

Preferably, the flow passage is structured and configured, such as in well known pressure reducing valves, so as to enable a predetermined outlet pressure to exit the outlet 14 from a received inlet pressure at the inlet 12. It is well known that the flow passage in these pressure reducing valves is self regulating in releasing the predetermined outlet pressure from the pressure reducing valve according to a received inlet pressure. Further, in these pressure reducing valves, the predetermined outlet pressure may vary as the inlet pressure varies and according to predetermined outlet pressure vs. inlet pressure relationships. It will be appreciated that the flow passage can be structured and configured as other well known existing pressure reducing valves. More preferably, these pressure reducing valves are intended to be maintained in an open state when installed or in use, and may be turned off in the closed state if desired. The inlet and outlet 12, 14 of the pressure reducing valve 10 may be suitably adapted for connection with a fluid delivery line 100. Such delivery lines may be but are not limited to piping of sprinkler systems and waterlines, which can be used in stairways and hallracks of various buildings.

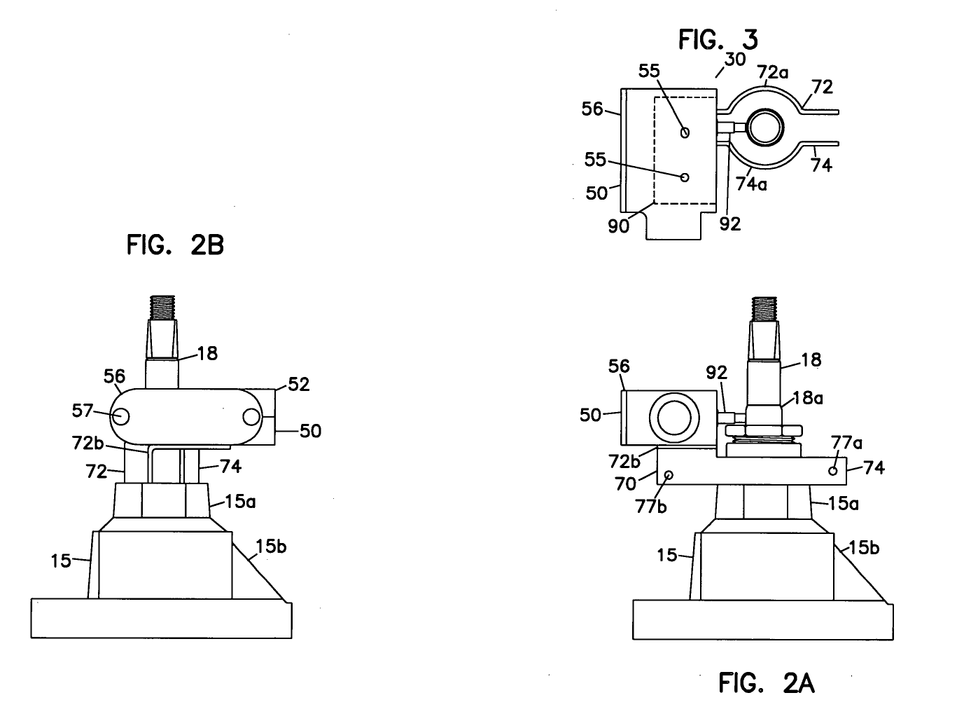

A flow actuating mechanism 30 is connected to the valve housing 16 through a connector 15. As shown in FIGS 1A through 2B, the connector 15 resembles a collar having a hex portion 15a disposed over a bonnet portion 15b. Preferably, the hex portion 15a and the bonnet portion 15b together threadably engage a stem 18 of the flow actuating mechanism 30 and the valve housing 16. Preferably, the hex portion 15a and the bonnet portion 15b are a one-piece structure adapted for connecting the stem 18 and the housing 16. It will be appreciated that the connector 15 structures may vary as needed to accomplish connection of the flow actuating mechanism 30 with the valve housing 16.

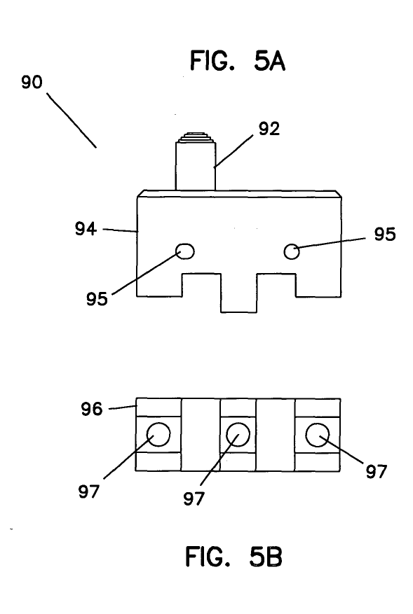

As above, the flow actuating mechanism 30 includes a stem 18 having a tamper switch 90 (best shown in FIG. 5) connected thereto and further discussed below. The stem 18 is rotatably connected with the valve housing 16 through the connector 15, and is removeably insertable with respect to the valve housing 16. The stem 18 actuates the pressure reducing valve 10 between open and closed states through rotating movement of the stem 18 with respect to the valve housing 16. Preferably, the stem is rotatable, such that rotation of the stem 18 in a clockwise and counterclockwise orientation adjusts the inserted position of the stem 18 relative to the valve housing 16. Preferably, the pressure reducing valve 10 is closed by rotating the stem 18 clockwise, and is opened by rotating the stem 18 counterclockwise. It will be appreciated that this configuration may be reversed where rotating the stem 18 counterclockwise closes the pressure reducing valve 10.

It is well known that insertion of the stem 18 into the valve housing 16 controls the open and closed states of the pressure reducing valve 10. Preferably, rotating the stem 18 to adjust an inserted position of the stem 18 relative to the valve housing 16 opens or closes the pressure reducing valve 10, thereby enabling or disabling a predetermined outlet pressure to exit the outlet 14 according to an inlet pressure received from the inlet 12. As above, it will be appreciated that the inlet pressure received may vary, and the outlet pressure may vary according to the inlet pressure received. Preferably, the pressure reducing valve is maintained in the open state.

As best shown in FIGS. 1A and 1B, the stem 18 may include a handwheel 19 connected with the stem 18 and rotatable along with the stem 18. Thus, the pressure reducing valve 10 may be manually operated. The handwheel may be manually rotated to impart rotative movement of the stem 18 in opening and closing the pressure reducing valve 10. Preferably, a bolt threadably connectable with the stem 18 is used to fasten the handwheel 19 to the stem 18. It will be appreciated that the handwheel 19 may be fastened to the stem 18 through other structures so that the handwheel 19 is rotatable along with the stem 18.

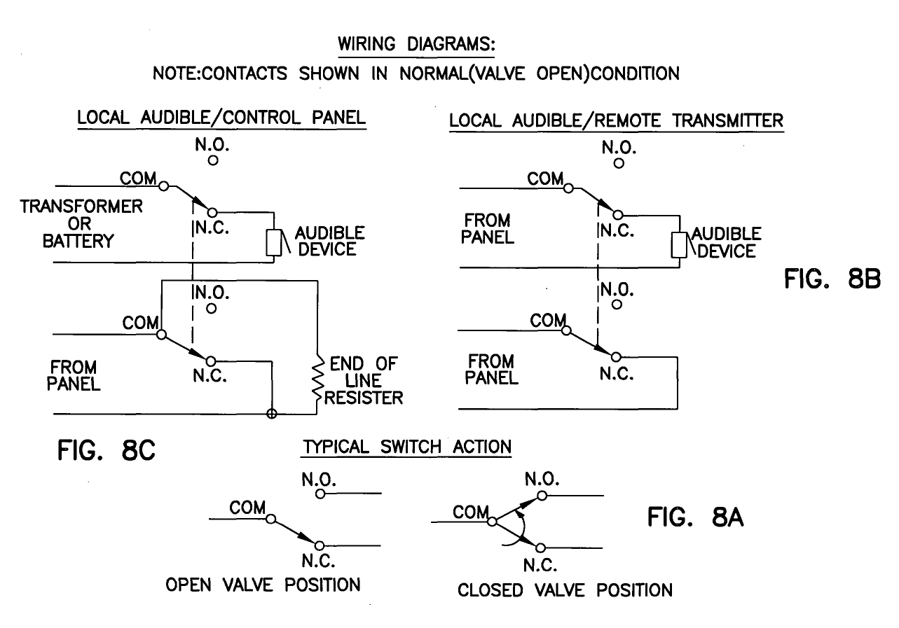

The switch 90 is mounted to and in direct communication with the stem 18 (FIG. 3). The switch 90 includes a wiring pattern (best shown in FIGS. 8A-C) for providing signals to indicate the operating position of the pressure reducing valve 10. Preferably, the switch 90 is mounted such that it is at least contained within a clearance space needed for the valve housing 16. Where a handwheel 19 is present (FIGS. 1A, 1B), the switch preferably is disposed on the stem 18 between the handwheel 19 and the valve housing 16. Further, the switch is mounted on the stem 18, such that it is contained within a clearance space needed for both the handwheel 19 and the housing 16 of the pressure reducing valve 10. In this mounting configuration, the switch 90 is maintained to a compact size, where no additional clearance is needed to accommodate the size of the switch 90.

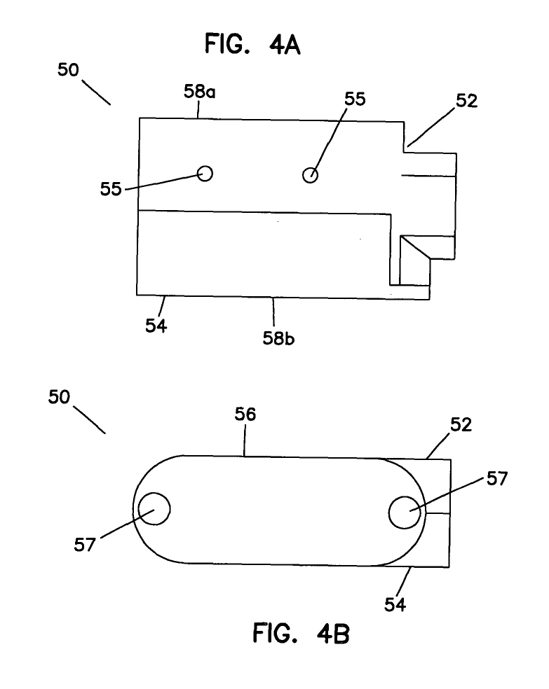

More preferably, the switch 90 is mounted to the stem 18 by a mounting bracket 70, and is contained in a switch housing 50. Preferably, the switch 90 is fastened with the switch housing 50, and together the switch 90 and the switch housing 50 are fastened to the mounting bracket 70. In assembly, the switch 90, switch housing 50 and mounting bracket 70 are mounted to the stem 18 through the mounting bracket 70. Preferably, the switch 90 communicates directly with the stem 18. The specific components of the switch housing 50, mounting bracket 70 and switch 90 are farther discussed in FIGS. 4A through 6C.

More preferably, the switch 90 is mounted to the stem 18. The switch 90 includes an actuator 92 fixed to the switch 90, and is compressibly engageable with the stem 18 (i.e. FIGS. 1B, 2B, 3 and 7A), such that the switch 90 is in direct communication with the stem 18. As shown, the actuator 92 presses against an outer surface 18a of the stem 18 when the valve is in the open position. Preferably, the outer surface 18a includes a tapered portion resembling a notch or step, where the actuator 92 rides along the outer surface 18a of the stem 18. Preferably, the tapered portion tapers away from the actuator 92 extending toward the top of the stem 18, and extends away from the valve housing 16. The stem 18 includes a wider portion at an end proximate the valve housing 16 than proximate the top. The tapered portion is such that when the stem 18 is rotated to adjust the inserted position into the valve housing 16, the actuator 92 comes into and out of compressed contact with the stem 18. Preferably, the actuator 92 is released from the compressed state when the valve is in the closed position.

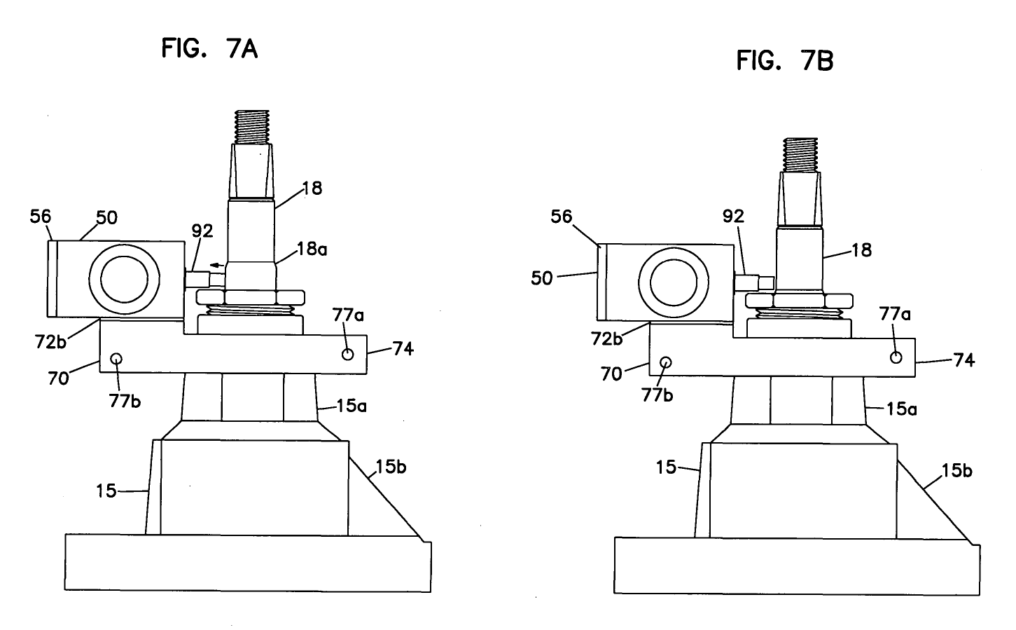

Preferably, the compressed contacted state of the actuator 92 with the stem 18 defines an operating state with the pressure reducing valve 10 opened to allow fluid flow. The released non-contacted state of the actuator 92 with the stem 18 defines an operating state with the pressure reducing valve 10 closed, so as to disable fluid flow. More preferably and as best shown in FIGS. 7A and 7B, the compressed contacted state is the open position and the non-contacted state is the closed position of the pressure reducing valve 10.

FIGS. 2A and 2B illustrate partial views of the pressure reducing valve 10 in FIGS. 1A and 1B. With the exception of the addition of the handwheel 19, similar features and parts as in FIGS. 1A and 1B are shown in FIGS. 2A and 2B and are not further discussed. FIGS. 2A and 2B illustrate that the mounted position of the switch 90 on the stem 18 enables the pressure reducing valve 10 to be monitored even in the event a handwheel 19 is missing, such as by removal or breakage.

FIG. 3 illustrates a top view of the switch 90 contained within the switch housing 50, as shown in FIGS. 2A and 2B (hidden lines). Particularly, the actuator 92 of the switch 90 is operatively connected with the switch 90 and extends out of the switch housing 50 so that contact can be made with the stem 18 in monitoring the operating condition of the pressure reducing valve 10.

FIG. 4A illustrates one preferred embodiment of a switch housing 50 for containing the switch 90. The switch housing 50 includes a top portion 52 and a bottom portion 54. A switch 90 may be housed between the top and bottom portions 52, 54. A front side 58a includes an opening (not shown) sized and configured for the actuator 92 of the switch 90 to extend outwardly from the switch housing 50 to enable contact with the stem 18. As illustrated in FIG. 4B, a retaining plate 56 is releasably connected to a rear 58b of the switch housing 50 such that the switch 90 can be retained and protected within the switch housing 50 (best shown in FIG. 3). Preferably, holes 57 on the retaining plate 56 are used to fasten the retaining plate 56 to the switch housing 50. It will be appreciated that other structures may be employed to retain the switch 90 within the switch housing 50.

FIGS. 5A and 5B illustrate one preferred embodiment of a switch 90 for monitoring the open and closed positions of the pressure reducing valve 10. The switch includes a cover 94 having the actuator 92 fixed thereto. Preferably, the actuator 92 extends outward from the cover 94 and through the front side 58a of the switch housing 50, and is operatively connected with switch components 96 residing within the cover 94. The actuator 92 is operatively connected with the switch components for enabling a signal to be created or broken for providing an operating condition of the valve. The switch components 96 are used for providing the operating condition of the valve 10 according to the disposition of the actuator 92, which is discussed below. In one preferred example only, the switch components 96 are well known components manufactured by Honeywell. More preferably, the switch components 96 are of the model Honeywell Micro Switch UL Listed-File E12252 Code L22 1A-125VAC. It will be appreciated that other well known switch components may be employed to accomplish the switch functions, as the present invention is not limited to any specific switch components or models.

The switch components 96 are disposed inside the cover 94, and may include connector ports 97 for operating the switch 90. Preferably, the switch 90 is powered by supplying power to one or more of the connector ports 97.

Preferably the actuator 92 resembles a plunger like member, such as a pin or bar that is deformable upon an applied pressure thereto. Preferably, the actuator 92 is constructed of an elastomeric material that is deformable when in contact with the stem 18. The actuator 92 is compressible in a perpendicular direction relative to movement of the stem 18 into and out of the housing 16. When compressed, the actuator enables the switch components to provide a signal that the valve is in the open positions.

Upon compression of the actuator 92 in a direction toward the cover 94 and when the actuator 92 is not in compressed contact with the stem 18, a signal respectively is created and broken to indicate an operating condition of the pressure reducing valve. The switch 90 is actuated when the actuator 92 is compressed by the outer surface 18a of the stem 18. Likewise, when the actuator 92 is not compressed, such as when not in contact with the stem 18, the actuator 92 returns to its normal expanded configuration. In this event, the signal is broken also indicating an operating condition of the pressure reducing valve. As above, the actuator 92 in the compressed configuration indicates an open state of the pressure reducing valve and the expanded configuration indicates a closed state of the pressure reducing valve.

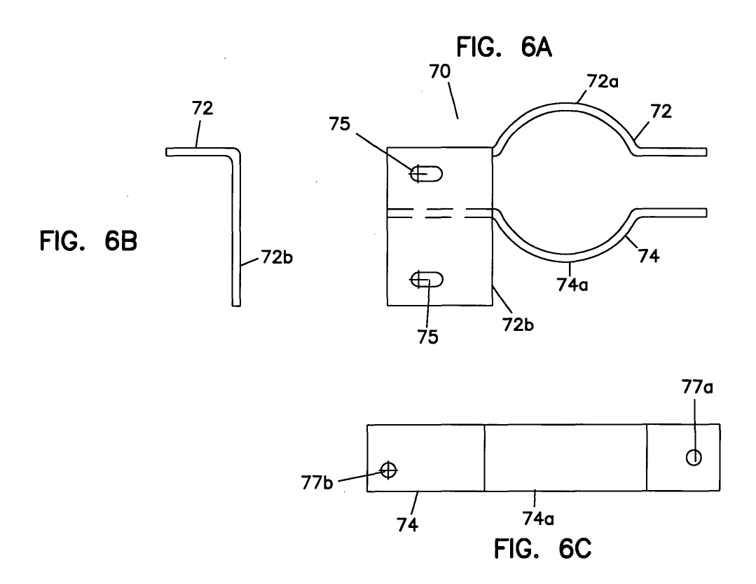

FIGS. 6A through 6C illustrate one preferred embodiment of a means for mounting the switch 90 to the stem 18. The mounting means includes a mounting bracket 70 for mounting the switch housing 50 and switch 90 to the stem 18 of the pressure reducing valve 10. The mounting bracket 70 includes a first side member 72 connected with a second side member 74 through a top plate 72b transversely extending on a top of each of the first and second side members 72, 74. The side members 72, 74 are disposed a distance apart from each other. The top plate 72b includes a surface for the switch housing 50 and switch 90 to connect with and rest upon. Preferably, the top plate 72b is disposed at corresponding ends of the side members 72, 74. More preferably, the top plate 72b is a perpendicularly folded plate portion of the first side member 72 (as best shown in FIG. 6B), and is connected with a top of the second side member 74 proximate corresponding ends of both the side members 72, 74.

Each of the side members 72, 74 includes a curved portion 72a, 74a. The curved portions 72a, 74a are oppositely disposed and extend outwardly away from each other and return toward each other. Preferably, the curved portions 72a, 74a resemble an open collar to enable the mounting bracket 70 to fit around the connector 15, preferably the hex portion 15a. Preferably, the side members 72, 74 are connected using through holes 77a, 77b disposed at ends of both of the side members (best shown in FIG. 6C), thereby the mounting bracket 70 can be securely mounted to the stem 18 (FIGS. 1A-2B). In FIG. 6C, only the through holes 77a, 77b of the second side member 74 are illustrated. It will be appreciated that the first side member also will include through holes corresponding with the through holes 77a, 77b of the second side member 74.

Preferably, the mounting bracket 70 includes through holes 75 on the top plate 72b, and the switch housing 50 and switch 90 each respectively include through holes 55, 95. These through holes 75, 55, 95 correspond with each other when the mounting bracket 70, switch housing 50 and switch 90 are assembled together, thereby enabling fastening of the mounting bracket 70, switch housing 50 and switch 90. Preferably, screws may be threadably engaged in the corresponding through holes 75, 55 and 95. It will be appreciated that other structures may be employed for fastening the switch housing 50 and switch 90 to the mounting bracket 70.

FIGS. 7A and 7B illustrate the preferred open and closed configurations of the pressure reducing valve 10. As above, the actuator 92 is deformable or compressible when in contact with the stem 18 (FIG. 7A) to actuate the switch 90. More preferably, the actuator 92 is compressible in a direction perpendicular (indicated by arrow) to the movement of the stem 18 into and out of the valve housing 16. Further, the switch 90 is activated or deactivated by the actuator 92 according to its contact with the outer surface 18a of the stem 18.

For example, in the open valve position of FIG. 7A, the actuator 92 and the stem 18 are in contact such that the actuator 92 is compressed, thereby creating a signal in the switch 90 and indicating that the pressure reducing valve 10 is properly operating in the open position.

Alternatively as in FIG. 7B, the actuator 92 is not in contact with the stem 18, thus enabling the actuator to return an non-compressed (or undeformed) state, thereby causing a break in the signal in the switch 90 and indicating that the pressure reducing valve is in the closed position.

As above, the stem 18 includes an outer surface 18a being a tapered surface. The tapered surface resembles a notch or step, where the actuator 92 is in contact or not in contact with the outer surface 18a, according to the inserted position of the stem 18 into or out of the valve housing 16. Preferably, the switch 90 is activated between open and closed positions of the pressure reducing valve within two turns of the stem 18 and/or handwheel 19. Thus, the actuator 92 of the switch 90 is engaged or disengaged with the stem within two turns of the stem 18 and/or handwheel 19. More preferably, this rotation degree corresponds to a distance of about 1/16 inches along the longitudinal axis of the stem 18, thereby providing a highly sensitive switch. It will be appreciated that the degree of rotation and the distance along the stem are merely exemplary as other degrees of rotation corresponding to different distances could be implemented according to a desired switch sensitivity. Similar features and components illustrated in FIGS. 7A and 7B have been described above, and are not further discussed.

FIGS. 8A-8C illustrate schematic diagrams for one preferred embodiment for wiring patterns in a switch, such as switch 90. Through activation by the actuator 92/stem 18 contact relationship, the switch 90 can be activated or deactivated to provide a signal including an indication of the operating condition of the pressure reducing valve. For example, the switch 90 provides a signal using the switch components 96. FIG. 8A illustrates a wiring diagram of a typical switch action for an open valve position and a closed valve position. FIG. 8B illustrates a wiring diagram for a local audible/remote transmitter. In this configuration, the switch may be operable for providing a local audible indication of the operating condition of the valve and for providing a signal to a remote location to indicate the same operating condition of the pressure reducing valve. It will be appreciated that the local audible indication is provided by an audible device, and may be but is not limited to a well known alarm. FIG. 8C illustrates a wiring diagram for a local audible/control panel. In this configuration, the switch may be operable for providing a local audible indication of the operating condition of the pressure reducing valve and for providing a signal to a local control panel. It will be appreciated that the switch 90 may be weather resistant suitable for both indoor and outdoor use, and may be wired using the common and the normally closed terminals.

Preferably, the pressure reducing valve 10 may have inlet and outlet sizes of 1.5 and 2.5 inches. Preferably, the 1.5 inch sized pressure reducing valves can reduce inlet pressures of 300 psi (2069 kPa) or less to desired working pressures of 10 to 175 psi (69-1207 kPa). Preferably, the 2.5 inch sized pressure reducing valves can reduce inlet pressures of 400 psi (2758 kPa) or less to a desired working pressure in the range of 20 to 175 psi (138-1207 kPa) under discharge or static conditions.

Exemplary dimensions corresponding, for instance, to the letters A, B, C and E in inches (mm) in FIG. 1A are given in Table 1 below:

| Size | A | B | C | E/Open | E/Closed | Weight |
|---|---|---|---|---|---|---|
| 1½ | 2 7/32 | 4 5/32 | 3¾ | 9 25/64 | 8 53/64 | 8 lb. - 13 oz. |
| | (56) | (106) | (95) | (239) | (224) | (3.70 kg.) |
| 2½ | 3 7/32 | 6 3/32 | 5¾ | 11⅜ | 10 13/16 | 21 lb. - 7 oz. |
| | (82) | (155) | (146) | (289) | (275) | (9.5 kg.) |
| 2½ | 3⅞ | 7¾ | 5¾ | 12¾ | 12 13/16 | 23 lb. - 15 oz. |
| | (98) | (197) | (146) | (324) | (325) | (10.5 kg.) |

It will be appreciated that these dimensions are exemplary only, as other dimensions may also be suitably employed.

Preferably, the valve housing 16, stem 18 and handwheel 19 are constructed of a cast chrome material. The switch housing 50 may be constructed of a zinc material. Further, the mounting bracket 70 may be constructed of a stainless steel material. It will be appreciated that these materials for the pressure reducing valve 10 components are merely exemplary, as other suitable materials also may be employed, such as other metals.

As above, the present invention provides a pressure reducing valve with a tamper switch mounted thereon with improved protection and durability characteristics. The configuration of the present invention employs a switch connected to the pressure reducing valve that is tamper proof. For instance, the structure for actuating the switch provides an improvement over cantilevered designs that may flex or buckle from a cantilevered load. The position of mounting the switch offers improved protection and reduces the chance of switch tampering, which can compromise the monitoring operation of the pressure reducing valve. Also, the present invention provides a compact pressure reducing valve with a tamper proof switch mounted, such that no further clearance is needed to accommodate the size of the switch. That is, the switch is mounted within the space taken up by the housing and handwheel, for instance between the handwheel and housing, where no additional clearance is needed. Further, the present invention can provide a pre-assembled pressure reducing valve with the switch mounted thereon that is cost effective.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A pressure reducing valve, comprising:
a valve including a housing having an inlet and an outlet defining a flow passage therethrough and a flow actuating mechanism connected to said housing, said flow actuating mechanism including a stem in communication with said inlet and outlet, said stem being rotatably connected to said housing and being at least partially rotatably insertable in said housing, said stem is operable for actuating the valve in an open state or in a closed state according to an inserted position of the stem;
a tamper switch mechanism mounted on said stem, said tamper switch mechanism including an actuator contactable with said stem such that said tamper switch mechanism being actuatable according to said inserted position of said stem, wherein said tamper switch mechanism enables said valve to be monitored in the open state and the closed state.

2. The pressure reducing valve according to claim 1, wherein said stem and actuator including a contact/non-contact relationship when said stem is rotated into and out said housing.

3. The pressure reducing valve according to claim 2, wherein contact/non-contact relationship including said actuator contacting said larger width of said stem when said valve is in said open state, and not contacting said smaller width in of said stem when said valve is in said closed state.

4. The pressure reducing valve according to claim 2, wherein said contact/non-contact relationship being a compressed/non-compressed engagement such that said actuator compressibly engages with said stem when the valve is in the open state and disengages from said stem when the valve is in the closed state.

5. The pressure reducing valve according to claim 1, wherein said stem is rotatably insertable a distance into and out of said valve to operate said valve in said open and closed states.

6. The pressure reducing valve according to claim 5, wherein said distance is about 1/16 inches into or out of said housing.

7. The pressure reducing valve according to claim 5, wherein said distance corresponding with two clockwise or counterclockwise turns of said stem.

8. The pressure reducing valve according to claim 1, wherein said stem including a tapered portion disposed thereon, said tapered portion defining a larger width proximate said housing and a smaller width proximate a top of said stem.

9. The pressure reducing valve according to claim 1, wherein said actuator is a pin or bar that is compressibly engageable with said stem.

10. The pressure reducing valve according to claim 9, wherein said actuator is an elastomeric material.

11. The pressure reducing valve according to claim 1, wherein said flow actuating mechanism further comprising a handwheel disposed at a top of said stem, said tamper switch mechanism being mounted on said stem and between said handwheel and said housing.

12. The pressure reducing valve according to claim 11, wherein said tamper switch mechanism being constructed and arranged such that said tamper switch mechanism is contained within a clearance space of said handwheel and said housing.

13. The pressure reducing valve according to claim 1, wherein said tamper switch mechanism including switch components operatively connected with said actuator, said actuator being operable for creating or breaking a signal within said switch components according to said inserted position of said stem to indicate an operating condition of said valve.

14. The pressure reducing valve according to claim 1, wherein said tamper switch mechanism further comprising an audible device so as to indicate an operating condition of said valve.

15. A fluid delivery system, comprising:
a fluid delivery line connected to a fluid source; and
a pressure reducing valve adaptable with said fluid delivery line to receive an inlet pressure from said fluid delivery line and control an outlet pressure exiting said pressure reducing valve; said pressure reducing valve including a housing having an inlet and an outlet defining a flow passage therethrough and a flow actuating mechanism connected to said housing, said flow actuating mechanism including a stem in communication with said inlet and outlet, said stem being rotatably connected to said housing and being at least partially rotatably insertable in said housing, said stem is operable for actuating the valve in an open state or in a closed state according to an inserted position of the stem;
a tamper switch mechanism mounted directly on said stem, said tamper switch mechanism including an actuator contactable with said stem such that said tamper switch mechanism being actuatable according to said inserted position of said stem, wherein said tamper switch mechanism enables said pressure reducing valve to be monitored in the open state and the closed state.

16. A method of monitoring tampering of a pressure reducing valve in a fluid delivery system, comprising:
providing a pressure reducing valve adaptable for connection with a fluid delivery line in said fluid delivery system to receive an inlet pressure from said fluid delivery line and control an outlet pressure exiting said pressure reducing valve, said pressure reducing valve including an inlet and an outlet defining a flow passage therethrough and a flow actuating mechanism, said flow actuating mechanism including a stem, said stem being at least partially rotatably insertable into said housing to control said pressure reducing valve in an open state or in a closed state according to an inserted position of said stem;
mounting a tamper switch mechanism on said stem, said tamper switch mechanism being actuatable according to said inserted position of said stem,
actuating said tamper switch mechanism; and
monitoring said pressure reducing valve wherein said tamper switch mechanism indicates an operating condition of said pressure reducing valve in the open state and in the closed state.
